(19) United States
(12) Patent Application Publication
(10) Pub. No.: US 2006/0006341 A1
(43) Pub. Date: Jan. 12, 2006

(54) Stage apparatus

(76) Inventors: Suk-won Lee, Gunpo-si (KR); Moon gu Lee, Suwon-si (KR)

Correspondence Address: STANZIONE & KIM, LLP, 919 18TH STREET, N.W., SUITE 440, WASHINGTON, DC, 20006, US

(21) Appl. No.: 11/082,825

(22) Filed: Mar. 18, 2005

(30) Foreign Application Priority Data
Jun. 23, 2004 (KR) 2004-47051

(51) Int. Cl. G01K 5/08; G01K 5/10

(52) U.S. Cl. 250/441.11

(57) ABSTRACT

A stage apparatus including a guide unit having a first guide and a second guide spaced from each other; a movable unit provided between the first guide and the second guide and being movable relative to the guide unit; an air bearing provided between the first guide and the movable unit and coupled to either the first guide or the movable unit; an actuator coupled to one of the movable unit and the second guide and contacting the other one thereof in order to allow the movable unit to be movable relative to the guide unit; and a stage coupled to one of the movable unit and the guide unit and being movable relative to the other one thereof. With this configuration, a stage apparatus which has a relatively simple structure and is easily assembled and disassembled is provided.

### CROSS-REFERENCE TO RELATED APPLICATIONS

This application claims the benefit of Korean Patent Application No. 2004-47051, filed on Jun. 23, 2004, in the Korean Intellectual Property Office, the disclosure of which is incorporated herein in its entirety and by reference.

### BACKGROUND OF THE INVENTION

1. Field of the Invention

The present general inventive concept relates to a stage apparatus, and more particularly, to a stage apparatus having an improved structure in moving a stage.

2. Description of the Related Art

Generally, a stage apparatus is used in a scanning apparatus to assist in providing a close examination of a semiconductor wafer, a liquid crystal display (LCD) or the like; a semiconductor processor; a super-precision machine; etc. The stage apparatus is of a linear motion driving mechanism which can drive an object such as the semiconductor wafer to move by a few hundreds of millimeters (mm) to a few nanometers (nm).

Such a stage apparatus generally comprises a stage supporting the semiconductor wafer or the like, a slider coupled to the stage and moving together with the stage, a guide to guide the slider, and an actuator provided between the guide and the slider and precisely driving the slider to move.

In the conventional stage apparatus, the guide generally penetrates the slider. In more detail, the guide has a rectangular section, and the slider has a guide through hole corresponding to the rectangular section of the guide, so that the guide is inserted in the guide through hole of the slider and supports the slider to be movable. However, because the guide has a structure of being inserted in the slider to guide the slider to move, the conventional stage apparatus has a relatively complicated structure. Further, because both the guide itself and the guide through hole of the slider should be processed to have rectangular section surfaces, production cost is increased. Still further, the guide and the slider are not easily assembled and disassembled.

### SUMMARY OF THE INVENTION

Accordingly, the present general inventive concept provides a stage apparatus which has a relatively simple structure and is easily assembled and disassembled.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a stage apparatus comprising a guide unit having a first guide and a second guide spaced from each other; a movable unit provided between the first guide and the second guide and being movable relative to the guide unit; an air bearing provided between the first guide and the movable unit and coupled to either the first guide or the movable unit; an actuator coupled to one of the movable unit and the second guide and contacting the other one thereof in order to allow the movable unit to be movable relative to the guide unit; and a stage coupled to one of the movable unit and the guide unit and being movable relative to the other one thereof.

The actuator may comprise a piezoelectric motor provided in the movable unit and vibrating and pressing the second guide, having an angle larger than a right angle to a surface of the second guide along a moving direction of the movable unit.

The actuator may comprise a frictional end part provided in an end of the piezoelectric motor and being contactable with the second guide.

One of the movable unit and the first guide may be provided with a protrusion, and the other one thereof may be provided with a protrusion accommodating portion to accommodate the protrusion.

At least one of the protrusion and the protrusion accommodating portion may be provided with the air bearing.

The protrusion and the protrusion accommodating portion may have triangular sections, respectively.

The first guide and the second guide may be disposed in parallel with each other.

The second guide may be formed with a contact portion including a material having high surface hardness to contact the actuator.

The first guide and the second guide are adjustable in a distance therebetween.

The air bearing may be plurally provided and press the movable unit toward the second guide in a direction perpendicular to the surface of the second guide.

The stage may be placed above the first guide and the second guide and coupled to the movable unit.

The stage may be coupled to the movable unit, leaving the second guide between the stage and the movable unit.

The second guide may form a pair of second guides spaced apart from each other, and the actuator may form a pair of actuators in correspondence to the pair of the second guides.

The movable unit and the guide unit each may be plurally provided, and the plurality of movable units may be moved relative to the plurality of guide units in the same direction.

The movable unit and the guide unit each may be plurally provided, and the plurality of movable units may be coupled to each other to respectively move in different directions so as to move the stage in various directions.

The piezoelectric motor may form a pair of piezoelectric motors, and one of the pair of piezoelectric motors may be installed having an angle larger than a right angle to a surface of the second guide along a moving direction of the movable unit, and the other one thereof may be installed having an angle smaller than the right angle to the surface of the second guide along the moving direction of the movable unit.

### BRIEF DESCRIPTION OF THE DRAWINGS

The above and/or other aspects and advantages of the present general inventive concept will become apparent and more readily appreciated from the following description of the embodiments, taken in conjunction with the accompany drawings of which:

FIG. 1 is a perspective view of a stage apparatus according to an embodiment of the present general inventive concept;

FIG. 2 is a sectional view of the stage apparatus of FIG. 1;

FIG. 3 is an exploded perspective view of the stage apparatus of FIG. 1;

FIG. 4 is a partial exploded perspective view of an actuator in the stage apparatus of FIG. 3;

FIG. 5 is a sectional view of a stage apparatus according to another embodiment of the present general inventive concept;

FIG. 6 is a sectional view of a stage apparatus according to yet another embodiment of the present general inventive concept; and

FIG. 7 is a perspective view of a stage apparatus according to yet another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

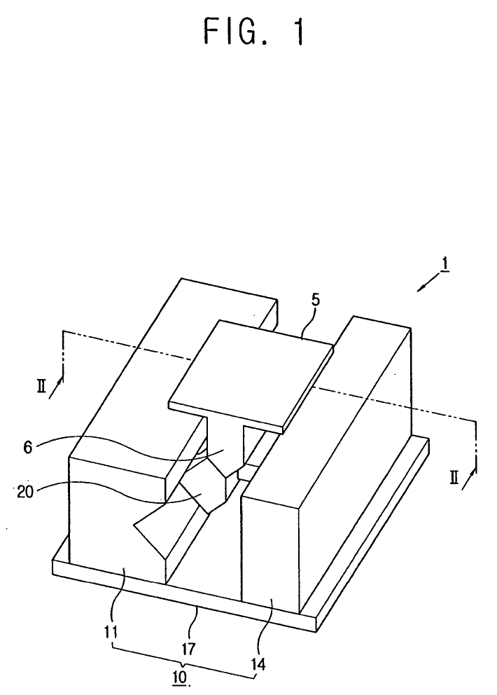

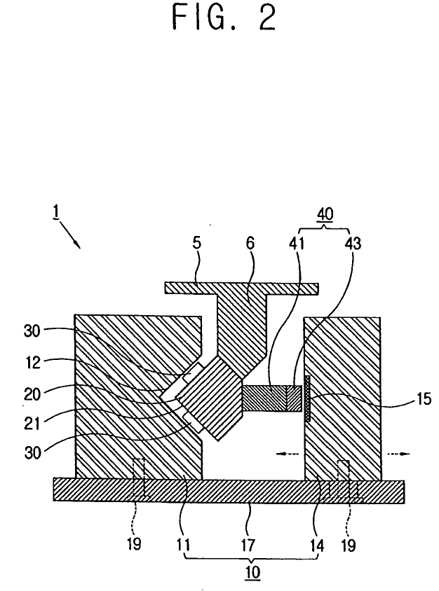

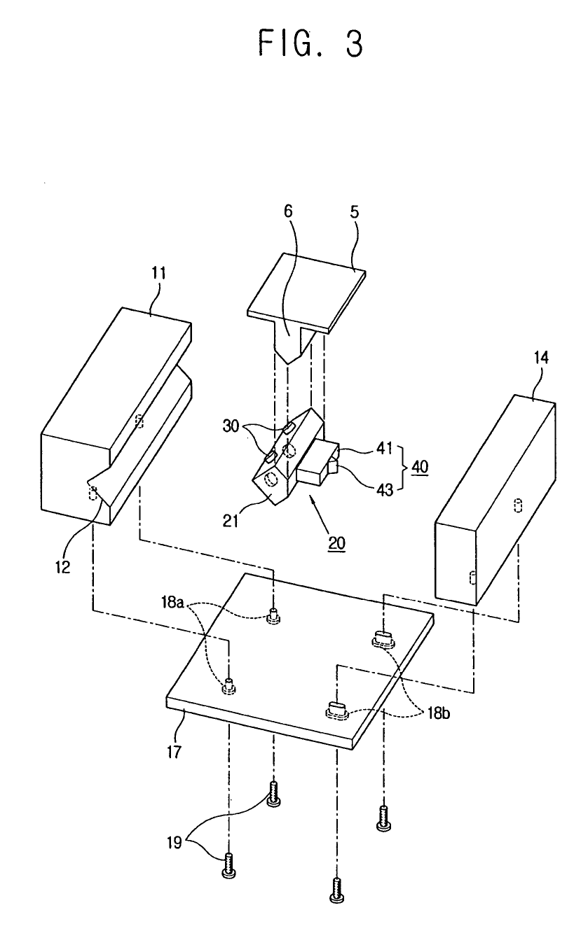

As shown in FIGS. 1 through 4, a stage apparatus 1 according to an embodiment of the present general inventive concept comprises a guide unit 10 having a first guide member 11 and a second guide member 14 spaced apart from each other; a movable unit 20 provided between the first guide 11 and the second guide 14 and being movable relative to the guide unit 10; an actuator 40 coupled to one of the movable unit 20 and the guide unit 10 and contacting the other one in order to allow the movable unit 20 to be movable relative to the guide unit 10; and a stage 5 coupled to one of the movable unit 20 and the guide unit 10 and being movable relative to the other one. Further, the stage apparatus 1 according to the present embodiment of the general inventive concept comprises an air bearing 30 placed between the first guide member 11 and the movable unit 20 and provided in at least one of the first guide member 11 and the movable unit 20. Further, the stage apparatus 1 according to the present embodiment comprises a position measuring unit (not shown) to measure a moved distance of the movable unit 20 relative to the guide unit 10.

The stage 5 may be shaped like a plate to support an object such as a semiconductor wafer, an LCD panel or the like. The stage 5 moves straightly with precision enough to have an error of 100 nm with respect to a moving distance by a few hundreds of millimeters. However, the stage may move straightly with precision enough to have an error of 100 nm or less with respect to a moving distance by a few hundreds of millimeters or more. According to the present embodiment, the stage 5 is coupled to the movable unit 20 by a stage supporter 6 and moves integrally with the movable unit 20 relative to the guide unit 10. The stage 5 is placed above the first guide member 11 and the second guide member 14 and coupled to the movable unit 20. However, the stage may be coupled to the guide unit 10 and may move relative to the movable unit 20.

The guide unit 10 supports the movable unit 20 to move relative to the guide unit 10. The guide unit 10 further comprises a guide base 17 supporting the first guide member 11 and the second guide member 14 which are spaced from each other.

The first guide member 11 may be shaped like a long block having a rectangular section. However, the first guide member 11 may have various sections such as a triangular section, a circular section, etc. Further, the first guide member 11 may be formed with a protrusion accommodating portion 12 to accommodate a protrusion 21 of the movable unit 20 (to be described later). However, the first guide 11 may be formed with the protrusion 21 and the movable unit 20 may be formed with the protrusion accommodating portion 12.

The protrusion accommodating portion 12 may have a triangular section. However, the protrusion accommodating portion 12 may have various sections such as a rectangular section, a semicircular section, etc., corresponding to the shape of the protrusion 21. Here, a distance between the first guide member 11 and the second guide member 14 can be adjustable.

The second guide member 14 can have a block shape having a rectangular section like the first guide member 11. However, the second guide member 14 may have various shaped sections, such as a triangular section or other polygonal type shaped section. The second guide member 14 can be disposed in parallel with the first guide member 11. That is, the second guide member 14 is coupled to the guide base 17 to be parallel with the first guide member 11. Further, the second guide member 14 is provided with a contact portion 15 to contact the actuator 40.

The contact portion 15 is precisely manufactured with a material having high surface hardness. That is, the contact portion 15 is in contact with a frictional end 43 of the actuator 40 (to be described later) to drive the movable unit 20 to move, so that the contact portion 15 is made of a metal material, a ceramic material, or the like which has a high surface hardness and is not easily deformed due to making contact.

The guide base 17 is shaped like a plate and supports the first guide member 11 and the second guide member 14 to be spaced apart from each other. Here, the guide base 17 allows a distance between the first guide member 11 and the second guide member 14 coupled thereto to be adjustable. That is, the guide base 17 may be coupled to the first guide member 11 and the second guide member 14 by a fastening bolt 19. Alternatively, another type fastening device that performs the intended purpose described above may be used. Further, the guide base 17 may comprise a fastening hole 18a to be coupled with one of the first guide member 11 and the second guide member 14 by the fastening bolt 19, and an elongated hole 18b to be coupled with the other one by the fastening bolt 19. Thus, one of the first guide member 11 and the second guide member 14 is movable through the elongated hole 18b, thereby adjusting the distance between the first guide member 11 and the second guide member 14.

The movable unit 20 is provided between the first guide member 11 and the second guide member 14 and may have a block shape. The movable unit 20 is provided with the protrusion 21 protruding in correspondence to the protrusion accommodating portion 12 of the first guide member 11. The movable unit 20 comprises the air bearing 30 provided in a first side thereof facing the first guide member 11 and the actuator 40 provided in a second side thereof facing the second guide member 14. The movable unit 20 may be provided with an air supply (not shown) to supply compressed air to the air bearing 30.

The protrusion 21 has a triangular section corresponding to the shape of the protrusion accommodating portion 12, but may have various sections corresponding to the shape of the protrusion accommodating portion 12.

According to the present embodiment, a plurality of air bearings 30 may be provided in the movable unit 20. Each of the air bearing(s) 30 blows compressed air toward the first guide member 11 to levitate the movable unit 20 from the first guide 11, thereby preventing friction between the movable unit 20 and the first guide 11 while the movable unit 20 moves. However, the air bearing 30 may be one in number, and may be placed in the first guide member 11 instead of in the movable unit 20. For example, the plurality of air bearings 30, when provided in plural, are placed in the protrusion 21 of the movable unit 20. However, the air bearings 30 may be placed in the protrusion accommodating portion 12 of the first guide member 11. Here, the air bearings would 30 urge the movable unit 20 in a direction perpendicular to a surface of the second guide member 14. That is, the plurality of the air bearings 30 press the movable unit 20 toward the second guide member 14 in a direction perpendicular to the surface of the second guide member 14. Thus, each air bearing 30 is supplied with air having a predetermined pressure, so that it is possible to adjust a preload of the actuator 40 initially being in contact with the second guide member 14.

The actuator 40 may be provided in the movable unit 20. However, the actuator 40 may alternatively be provided in the second guide member 14. The actuator 40 comprises a piezoelectric motor 41 periodically vibrating and pressing the second guide member 14, having an angle larger than a right angle to the surface of the second guide member 14 in a moving direction of the movable unit 20. Further, the actuator 40 comprises a frictional end 43 provided at an end of the piezoelectric motor 41 and being contactable with the second guide member 14.

The piezoelectric motor 41 operates based on a principle that a piezoelectric vibrator vibrates by alternating current, and transforms vibrating motion into straight motion by slantingly contacting a facing surface in a right angle direction to the facing surface. Further, the piezoelectric motor 41 can be connected with an amplifier (not shown) to amplify the alternating current supplied to the piezoelectric motor 41 or adjust the frequency of the alternating current.

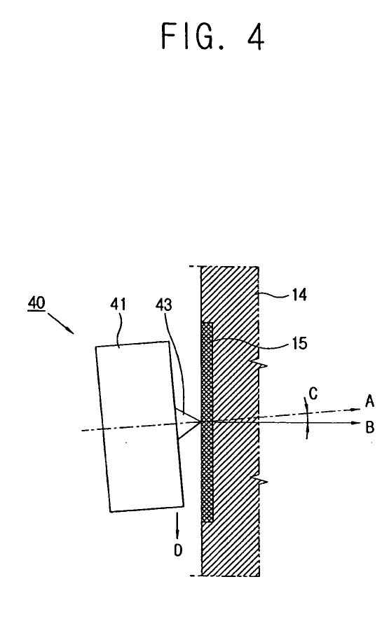

The piezoelectric motor 41 vibrates and presses the second guide member 14 in the moving direction of the movable unit 20, having an angle larger than the right angle to the surface of the second guide 14. As shown in FIG. 4, a pressing direction “A” of the piezoelectric motor 41 forms an inside angle “C” with respect to the right angle “B” to the contact portion 15. Such an inside angle “C” is formed along a moving direction “D” of the movable unit 20. The larger the inside angle “C” is, the faster the movable unit 20 moves, wherein the moving speed of the movable unit 20 is preferably adjusted in consideration of precision. Such an inside angle is preferably of 1° through 10°, but may be of 10° or more. Thus, the piezoelectric motor 41 can drive the movable unit 20 to move relative to the guide unit 10 in the moving direction “D.” Here, the piezoelectric motor 41 may form at least one pair of motors. That is, one of the pair of piezoelectric motors 41 can be installed having an angle larger than the right angle to the surface of the second guide member 14 along the moving direction “D” of the movable unit 20, and the other one of the motors 41 can be installed having an angle smaller than the right angle to the surface of the second guide member 14 along the moving direction “D” of the movable unit 20. Thus, the pair of piezoelectric motor 41 can drive the movable unit 20 to move in the moving direction “D” or in an opposite direction to the moving direction “D.”

The frictional end 43 of the actuator 40 has a first end coupled to the piezoelectric motor 41 and a second end tapered to be in contact with the second guide member 14. The frictional end 43 of the actuator 40 can have a triangular section and can include the first end coupled to the piezoelectric motor 41 and the second end having a vertex to contact the contact portion 15 of the second guide 14 due to the vibration of the piezoelectric motor 41. The frictional end 43 of the actuator 40 is precisely made of a high stiffness material. That is, the frictional end 43 is made of a metal material, a ceramic material, etc. having high stiffness. Thus, the frictional end 43 of the actuator 40 is in contact with the contact portion 15 due to the vibration of the piezoelectric motor 41, thereby moving the movable unit 20 in the moving direction.

With this configuration, the stage apparatus 1 according to the present embodiment of the present general inventive concept can be assembled and operated as follows.

In an assembling process of the stage apparatus 1, the movable unit 20 provided with the air bearing 30 and the actuator 40 is placed between the first guide member 11 and the second guide member 14. Then, the first guide member 11 and the second guide member 14 are fastened to the guide base 17, properly adjusting the distance therebetween. On the other hand, a disassembling process of the stage apparatus 1 is performed in just a reverse order, and therefore detailed descriptions of this process will be omitted.

In an operating process of the stage apparatus 1, the air pressure is properly adjusted to support the preload of the actuator 40 and then the air is supplied to the air bearing 30, thereby allowing the actuator 40 to press the second guide member 14. Then, the piezoelectric motor 41 of the actuator 40 is turned on to vibrate. Then, the frictional end 43 coupled to the piezoelectric motor 41 repetitively contacts the contact portion 15 coupled to the second guide member 14, thereby moving the movable unit 20. Thus, the stage 5 coupled to the movable unit 20 is moved relative to the guide unit 10.

As described above, in the stage apparatus 1 according to present embodiment, the movable unit 20 is supported between the first guide member 11 and the second guide member 14, so that the stage apparatus 1 has a simple structure and is easily assembled and disassembled. Further, in the stage apparatus 1 according to the present embodiment, the air bearing 30 is supplied with air by the proper air pressure, thereby easily adjusting the preload of the actuator 40 pressing the second guide member 14.

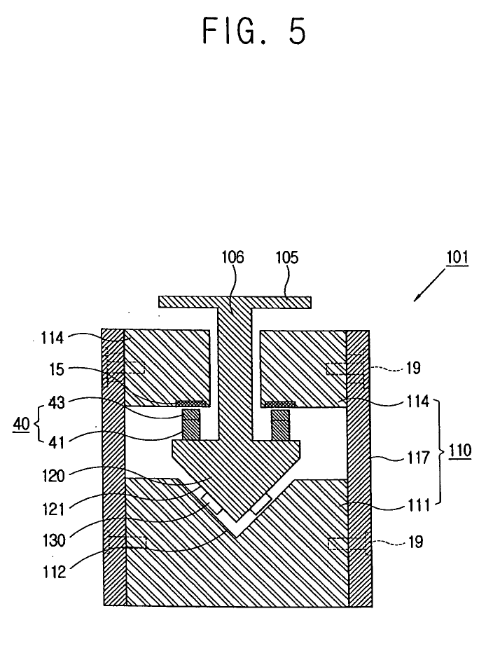

FIG. 5 is a sectional view of a stage apparatus according to another embodiment of the present general inventive concept. As shown therein, a stage apparatus 101 according to the present embodiment is different in an installation position of a stage 105 from that of the previous embodiment.

The stage 105 is coupled to a movable unit 120, leaving a second guide member 114 of a guide unit 110 between the stage 105 and the movable unit 120. As shown in FIG. 5, a pair of second guide members 114 are spaced from each other and disposed above a first guide member 111. The movable unit 120 is provided between the first guide member 111 and the second guide member 114. The stage 105 is disposed above the second guide 114. The stage 105 is coupled to the movable unit 120 with a stage supporter 106 provided between the pair of second guide members 114, thereby moving integrally with the movable unit 120 relative to the guide unit 110.

At least one side of opposite sides of both the first guide member 111 and the second guide member 114 is coupled with a guide supporter 117 by a fastening bolt 19. A protrusion accommodating portion 112 is formed on the first guide member 111, and a protrusion 121 is provided under the second guide member 114. The bottom of each second guide member 114 is provided with a contact portion 15 to be in contact with a frictional end 43 of an actuator 40. Here, the actuator 40 is provided on the movable unit 120 and forms a pair of actuators 40 in correspondence to the pair of second guide members 114.

With this configuration, in the stage apparatus 101 according to this embodiment, air of proper pressure is supplied to an air bearing 130 coupled to the movable unit 120 to support preload of the actuator 40, and the piezoelectric motors 41 of the actuator 40 are turned on to move the movable unit 120 relative to the guide unit 110.

Further, in the stage apparatus 101 according to the embodiment of FIG. 5, when the stage apparatus 101 does not operate and stops supplying air, the protrusion 121 of the movable unit 120 is landed in balance on the protrusion accommodating portion 112 of the first guide 111 by its own weight. Therefore, the precision and the life span thereof are improved and prolonged. Further, like that of the previous embodiment, the stage apparatus 101 according to the embodiment of FIG. 5 has simple configurations, can easily adjust the preload of the actuator 40, and is easily assembled and disassembled.

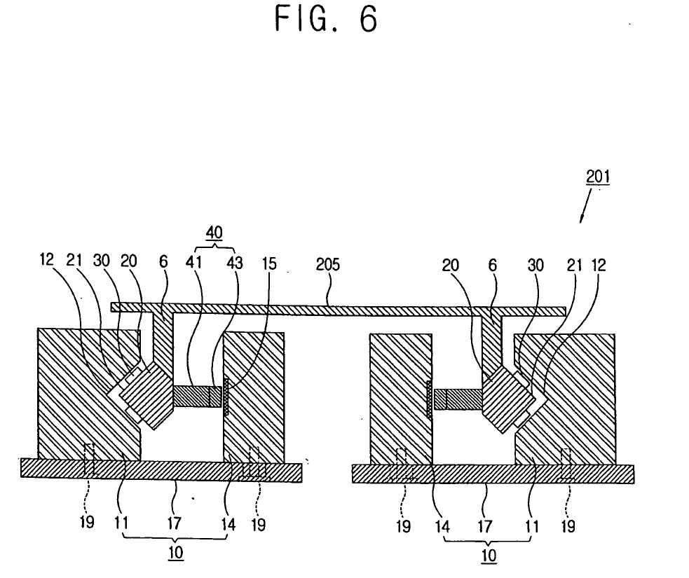

FIG. 6 is a sectional view of a stage apparatus according to another embodiment of the present general inventive concept. As shown therein, a stage apparatus 201 according to this embodiment comprises a plurality of movable units 20, and a plurality of guide units 10, differently from that of the embodiment of FIGS. 1-4, wherein the plurality of movable units 20 moves relative to the plurality of the guide units 10 in the same direction.

For example, a pair of guide units 10 and a pair of movable units 20 are provided to be coupled with opposite ends of a stage 205. However, two pairs or more of guide units 10 and two pairs or more of movable units 20 may be provided to be coupled with the stage 205. Further, the pair of movable units 20 is coupled to the stage 205 and moves together with the stage 205. However, the pair of guide units 10 may be coupled with the stage 205.

Each guide unit 10 comprises the first guide member 11 and the second guide member 14, and the movable unit 20 coupled with the air bearing 30 and the actuator 40 are configured like those of the embodiment of FIGS. 1-4, so that detailed descriptions thereof will be omitted. However, the guide units 10 and the movable units 20 according to the present embodiment may be configured like those of the previous embodiment of FIG. 5.

With this configuration, in the stage apparatus 201 according to the present embodiment, the stage 205 and the movable units 20 can be moved relative to the guide units 10.

Further, in the stage apparatus 201 according to the present embodiment, the movable units 20 and the guide units 10 are plurally provided to support the stage 205, thereby more precisely moving the stage 205. Further, like that of the embodiment of FIGS. 1-4, the stage apparatus 201 according to the present embodiment of FIG. 6 has simple configurations, can easily adjust the preload of the actuator 40, and is easily assembled and disassembled.

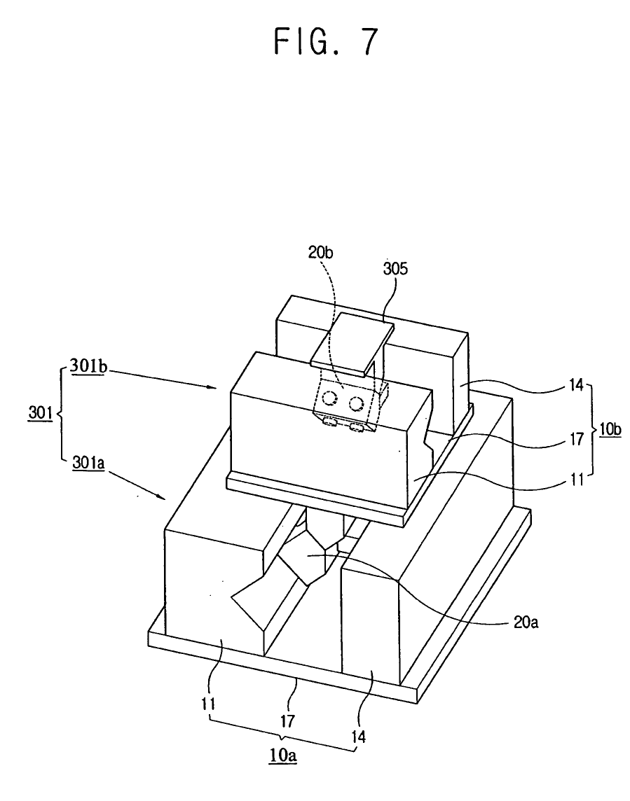

FIG. 7 is a perspective view of a stage apparatus according to another embodiment of the present general inventive concept. As shown therein, a stage apparatus 301 according to the present embodiment comprises a plurality of movable units 20a and 20b, and a plurality of guide units 10a and 10b, provided differently from that of the FIGS. 1-4 embodiment, wherein the plurality of movable units 20a and 20b moves relative to the plurality of the guide units 10 in different directions, respectively.

For example, the guide units 10a and 10b and the movable units 20a and 20b are piled up. That is, a second stage apparatus 301b is piled up on a first stage apparatus 301a (the same as disclosed in the embodiment of FIGS. 1-4). Further, the first movable unit 20a and the second movable unit 20b are moved in different directions, for example, in a direction having a right angle to each other. Also, the first guide unit 10a and the second guide unit 10b are installed along different directions corresponding to the first movable unit 20a and the second movable unit 20b. Thus, the stage 305 coupled to the second movable unit 20b can move in various directions.

With this configuration, in the stage apparatus 301 according to the fourth embodiment of FIG. 7, the stage 305 and the movable unit 20b can be moved relative to the first and second guide units 10a and 10b, respectively.

Further, in the stage apparatus 301 according to FIG. 7, the stage 305 can move in various directions. Further, like that of the embodiment of FIGS. 1-4, the stage apparatus 301 according to the present embodiment has simple configurations, can easily adjust the preload of the actuator 40, and is easily assembled and disassembled.

As described above, the present general inventive concept provides a stage apparatus having a simple structure and being easily assembled and disassembled.

Further, the present general inventive concept provides a stage apparatus in which preload of an actuator is easily adjusted by supplying air of proper pressure.

Although various embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A stage apparatus comprising:
a guide unit having a first guide member and a second guide member spaced from each other;
a movable unit provided between the first guide member and the second guide and being movable relative to the guide unit;
an air bearing provided between the first guide member and the movable unit and coupled to either the first guide member or the movable unit;
an actuator coupled to one of the movable unit and the second guide member and contacting the other one thereof to allow the movable unit to be movable relative to the guide unit; and
a stage coupled to one of the movable unit and the guide unit and movable relative to the other one thereof.

2. The stage apparatus according to claim 1, wherein the actuator comprises a piezoelectric motor provided in the movable unit and vibrating and pressing the second guide member, having an angle larger than a right angle to a surface of the second guide member along a moving direction of the movable unit.

3. The stage apparatus according to claim 2, wherein the actuator comprises a frictional end part provided in an end of the piezoelectric motor and being contactable with the second guide member.

4. The stage apparatus according to claim 1, wherein one of the movable unit and the first guide member is provided with a protrusion, and the other one thereof is provided with a protrusion accommodating portion to accommodate the protrusion.

5. The stage apparatus according to claim 4, wherein at least one of the protrusion and the protrusion accommodating portion is provided with the air bearing.

6. The stage apparatus according to claim 4, wherein the protrusion and the protrusion accommodating portion have triangular sections, respectively.

7. The stage apparatus according to claim 1, wherein the first guide member and the second guide member are disposed in parallel with each other.

8. The stage apparatus according to claim 1, wherein the second guide member is formed with a contact portion including a material having high surface hardness to contact the actuator.

9. The stage apparatus according to claim 1, wherein the first guide member and the second guide member are adjustable in a distance therebetween.

10. The stage apparatus according to claim 1, wherein the air bearing is plurally provided and presses the movable unit toward the second guide member in a direction perpendicular to the surface of the second guide member.

11. The stage apparatus according to claim 1, wherein the stage is placed above the first guide member and the second guide member and coupled to the movable unit.

12. The stage apparatus according to claim 1, wherein the stage is coupled to the movable unit, leaving the second guide member between the stage and the movable unit.

13. The stage apparatus according to claim 12, wherein the second guide member forms a pair spaced from each other, and the actuator forms a pair in correspondence to the pair of the second guide members.

14. The stage apparatus according to claim 1, wherein the movable unit and the guide unit each are plurally provided, and the plurality of movable units are moved relative to the plurality of guide units in the same direction.

15. The stage apparatus according to claim 1, wherein the movable unit and the guide unit each are plurally provided, and
the plurality of movable units are coupled to each other to respectively move in different directions to move the stage in various directions.

16. The stage apparatus according to claim 2, wherein the piezoelectric motor forms a pair, and
one of the pair of piezoelectric motors is installed having an angle larger than a right angle to a surface of the second guide member along a moving direction of the movable unit, and the other one thereof is installed having an angle smaller than the right angle to the surface of the second guide member along the moving direction of the movable unit.

17. A stage apparatus comprising:
a guide unit including a base and a pair of guide members adjustably fastened to the guide base to adjust a space therebetween, one of the pair of guide members having a protrusion accommodating portion therein;
a movable unit provided between the pair of guide members and having a protrusion portion provided at a first side thereof and accommodatable within the protrusion accommodating portion;
a first stage extending from the movable unit to be movable therewith; and
a driving unit to drive the movable unit between the guide members such that the protrusion portion slides along a length of the protrusion accommodating portion.

18. The stage apparatus according to claim 17, wherein the driving unit comprises:
an air bearing member provided between and connected to one of the protrusion accommodating portion and the protrusion portion to prevent friction therebetween; and
an actuator connected to a second side of the movable unit opposite to the first side thereof and adjacent to the other one of the pair of guide members to provide movement of the movable unit with respect to the pair of guide members.

19. The stage apparatus according to claim 17, further comprising:
a second guide unit connected to an upper surface of the stage and including a second base and a second pair of guide members adjustably fastened to the second guide base to adjust a space therebetween, one of the second pair of guide members having a second protrusion accommodating portion therein;
a second movable unit provided between the second pair of guide members and having a second protrusion portion provided at a first side thereof and accommodatable within the second protrusion accommodating portion, the second movable unit movable in a direction perpendicular to the movable unit;
a second stage extending from the second movable unit to be movable therewith; and
a driving unit to drive the second movable unit between the second pair of guide members such that the second protrusion portion slides along a length of the second protrusion accommodating portion.

20. A stage apparatus comprising:
a guide unit including a base and a pair of first and second guide members, each of the pair of first and second guide members being adjustably fastened to the guide base to adjust a space therebetween, the first guide member having a protrusion accommodating portion therein;
a movable unit provided between each of the first and second guide members and having a protrusion portion provided at a first side thereof and accommodatable within the respective protrusion accommodating portion;
a stage extending at opposite ends thereof from a respective one of the movable units; and
a pair of driving units, each driving unit being connected with a respective movable unit to drive the respective movable unit between the respective first and second guide members such that the protrusion portion slides along a length of the respective protrusion accommodating portion.

21. The stage apparatus according to claim 20, wherein each driving unit comprises:
an air bearing member provided between and connected to one of the protrusion accommodating portion and the protrusion portion to prevent friction therebetween; and
an actuator connected to a second side of the movable unit opposite to the first side thereof and adjacent to the second guide member to provide movement of the movable unit with respect to the first and second guide members.

22. The stage apparatus according to claim 21, wherein the actuator comprises a piezoelectric motor that presses the second guide member in a vibrating motion and has an angle larger than a right angle to a surface of the respective second guide member along a moving direction of the movable unit.

23. The stage apparatus according to claim 22, wherein the actuator comprises a frictional end part provided at an end of the piezoelectric motor and being contactable with the respective second guide member.

24. The stage apparatus according to claim 23, wherein each of the second guide members comprise a contact portion including a material having high surface hardness to contact the respective frictional end part.
